(19) United States
(12) Patent Application Publication
(10) Pub. No.: US 2020/0378927 A1
(43) Pub. Date: Dec. 3, 2020

(54) INSPECTION SYSTEM, MOBILE ROBOT DEVICE, AND INSPECTION METHOD

(71) Applicant: NEC Corporation, Tokyo (JP)

(72) Inventors: Toshihiro NISHIZAWA, Tokyo (JP); Toshiaki YAMASHITA, Tokyo (JP); Namiki HASHIMOTO, Tokyo (JP); Hideo ADACHI, Tokyo (JP); Hiroshi MUROFUSHI, Tokyo (JP); Motoaki SHIMIZU, Tokyo (JP); Akira KOYASHIKI, Tokyo (JP); Kenzo NONAMI, Chiba (JP); Daisuke IWAKURA, Chiba (JP); Tytus WOJTARA, Chiba (JP); Kohji INAGAKI, Chiba (JP); Naotaka SHIKIDA, Tokyo (JP); Satoshi AOKI, Tokyo (JP)

(73) Assignee: NEC Corporation, Tokyo (JP)

(21) Appl. No.: 16/305,724

(22) PCT Filed: Jun. 14, 2017
(86) PCT No.: PCT/JP2017/022009

§ 371 Date: Nov. 29, 2018

(30) Foreign Application Priority Data
Jun. 16, 2016 (JP) 2016-119753

(51) Int. Cl. G01N 29/265; G01N 29/04; G05D 1/00; G05D 1/10; G01S 13/89; G01N 21/88; G01N 29/24; B64C 39/02; B64D 47/08

(52) U.S. Cl. CPC G01N 29/265; E04G 23/00; G05D 1/0088; G05D 1/101; G05D 1/0094; G01S 13/89; G01N 21/8851; G01N 29/24; B64C 39/024; B64D 47/08; G01N 2291/2698; B64C 2201/123; B64C 2201/146; B64C 2201/145; B64C 2201/126; G01N 29/04

(57) ABSTRACT

The present invention makes it possible for sounding of an inspection location on an outer wall of a building or the like to be performed using a simple operation. A user interface device accepts an input for designating an inspection location. The mobile robot device flies autonomously and moves to the inspection location, on the basis of the input into the user interface device and the current location of the mobile robot device. The mobile robot device inspects the inspection location using an inspection means such as a sounding means.

### TECHNICAL FIELD

This invention relates to a method and system for inspecting a tunnel, a bridge, or a similar structure/building.

### BACKGROUND ART

An exterior wall flaking detection system described in Patent Document 1 can be given as an example of a technology in which a mobile object is used to check for defects in a wall of a tunnel, a bridge, or a similar structure. This system includes a detection device placed outdoor and a monitoring/operation device with which the detection device is operated remotely. The detection device is mounted on a flying object, for example, a radio-controlled helicopter. The flying object includes a flying object operation receiver, which receives a control signal transmitted from the monitoring/operation device, as well as a percussor, a sound collection device, and a percussion sound transmitter, which are used for a hammering test. The monitoring/operation device includes a flying object operation transmitter, a percussion sound receiver, and a speaker. A user uses the monitoring/operation device to remotely operate the flying object, and conducts percussion on an inspection target with the use of the percussor. A sound issued from the inspection target in response to the percussion is collected by the sound collection device, and is played back on the speaker via the percussion sound transmitter and the percussion sound receiver. This enables the user to determine whether there is an anomaly in the inspected site by listening to the percussion sound, without approaching the inspection target.

### PRIOR ART DOCUMENT(S)

### Patent Document(s)

Patent Document 1: JP 2012-145346 A

### SUMMARY OF THE INVENTION

### Problem to be Solved by the Invention

According to Patent Document 1, the user is required to remotely operate the flying object when the flying object is to approach the inspection target. A degree of skill in the remote operation of the flying object is accordingly required of the user despite the objective in Patent Document 1, which is to conduct percussion on an inspection site. The system of Patent Document 1 is consequently somewhat limited in the range of users. The surroundings of a bridge or a tunnel are not always an environment suitable for the operation of a radio-controlled helicopter or the like, and are rather an environment unsuitable for such operation in some cases. In this case in particular, only a few with great skill can perform inspection work. If a person with ordinary skill performs inspection work in this case, just the piloting of the flying object to a desired inspection site takes long and the overall length of the inspection work is prolonged as a result.

This invention has been made in view of the situation described above, and an object of this invention is therefore to provide a technology with which, when percussion is to be conducted on an exterior wall of a tunnel, a bridge, or a similar structure, or a high-rise building or a similar building, with the use of a flying object including a percussor, a desired inspection site can be inspected by percussion with simple operation.

### Means to Solve the Problem

In order to solve the problem mentioned above, this invention provides, as an aspect of the invention, an inspection system comprising: a mobile robot device; a user interface device; and position obtaining means for obtaining a current position of the mobile robot device, wherein the mobile robot device includes: inspection means including, at least, percussion means for inspecting an inspection site by hitting an anomalous site; flying means for flying the mobile robot device; map creation means for generating map data, which indicates a positional relation between the current position of the mobile robot device and an inspection site specified via the user interface device, based on the specified inspection site and on the current position obtained by the position obtaining means; and an autonomous control means for controlling the flying means based on the current position and the map data so that the mobile robot device autonomously travels to a point at which an inspection of the inspection site is executable with the inspection means, and wherein the user interface device includes: inspection site input means for receiving input of a location of the inspection site by a user; and inspection result recording means for recording the location of the inspection site and output of the inspection means in association with each other.

Further, this invention provides, as another aspect of the present invention, a mobile robot device to be used together with a user interface device and position obtaining means for obtaining a current position of the mobile robot device, the mobile robot device comprising: inspection means including, at least, percussion means for inspecting an inspection site by hitting an anomalous site; flying means for flying the mobile robot device; map creation means for generating map data, which indicates a positional relation between the current position of the mobile robot device and an inspection site specified via the user interface device, based on the specified inspection site and on the current position obtained by the position obtaining means; and autonomous control means for controlling the flying means based on the current position and the map data so that the mobile robot device autonomously travels to a point at which an inspection of the inspection site is executable with the inspection means, wherein the user interface device includes: inspection site input means for receiving input of a location of the inspection site by a user; and inspection result recording means for recording the location of the inspection site and output of the inspection means in association with each other.

Further, as another aspect of the present invention, this invention provides an inspection method, comprising the steps of: receiving, by a user interface device, input for specifying an inspection site; causing a mobile robot device to autonomously fly and travel to the inspection site, based on the input to the user interface device and a current position of the mobile robot device; and inspecting the inspection site with one or a plurality of inspection means, which include percussion means provided in the mobile robot device.

### Effect of the Invention

According to the embodiments of this invention, when percussion is to be conducted with the use of a flying object including a percussor, a desired inspection site can be inspected by percussion with simple operation.

### BRIEF DESCRIPTION OF THE DRAWING

FIG. 1 is a block diagram of an inspection system 1 according to an embodiment of this invention.

FIG. 2 is a block diagram for illustrating a flight unit 4 of a mobile robot device 2.

FIG. 3 is a block diagram for illustrating an inspection unit 5 of the mobile robot device 2.

FIG. 4 is a block diagram for illustrating a user interface device 3.

FIG. 5 is a flow chart for illustrating the operation of the inspection unit 5.

FIG. 6 is a flow chart for illustrating the operation of the mobile robot device 2.

FIG. 7 is a flow chart for illustrating the operation of the user interface device 3.

FIG. 8 is a block diagram for illustrating a modification of a percussion unit 51.

### MODE FOR EMBODYING THE INVENTION

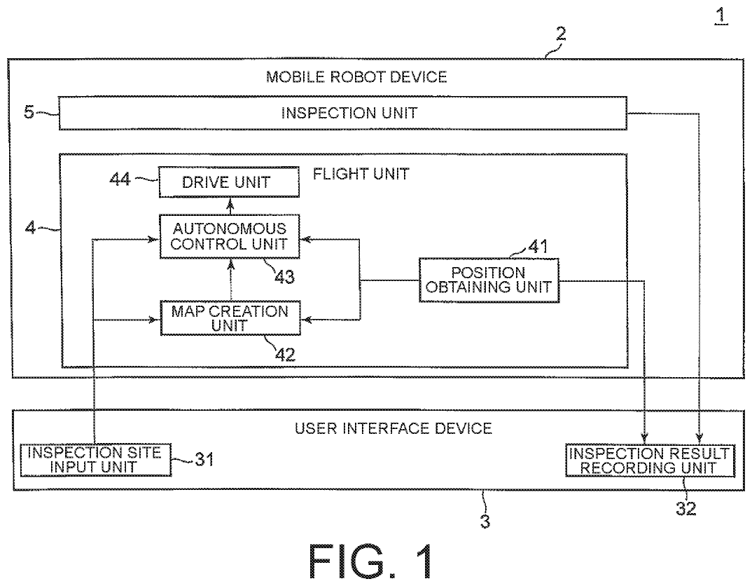

An inspection system 1 according to an embodiment of this invention is described. Referring to FIG. 1, the inspection system 1 includes a mobile robot device 2 and a user interface device 3. The mobile robot device 2 includes a flight unit 4 and an inspection unit 5. The mobile robot device 2 and the user interface device 3 hold data communication via a wireless data communication line.

The mobile robot device 2 is what is called a drone, and is an autonomously flying and unmanned aircraft. Generally speaking, most drones are rotor crafts, which fly by generating a lift force with rotor blades, and the number of multi-copters including tricopters, which have three rotors, and quadcopters, which have four rotors, is particularly high. A drone used as the mobile robot device 2 can have any number of rotors, and may be a single-rotor drone or a twin-rotor drone.

The mobile robot device 2 is not always required to be a rotor craft. The mobile robot device 2 may be any device which has an inspection unit 5 capable of inspecting an inspection site at high altitude. The mobile robot device 2 is accordingly not limited to a particular flight principle as long as the adopted principle allows the mobile robot device 2 to fly and stay in the air in the vicinity of an inspection site long enough to perform inspection work. Other than rotor crafts, a hot balloon or an airship, for example, can be used as the mobile robot device 2.

The mobile robot device 2 uses the flight unit 4 to fly to an inspection site, which is located at a point input in advance, from a point PS at which the mobile robot device 2 is initially placed. The mobile robot device 2 then uses the inspection unit 5 to perform inspection work on the inspection site. The mobile robot device 2 subsequently uses the flight unit 4 once more to move to a given point PE (for example, the above-mentioned initially placed point). The flight from the point PS via the inspection site to the point PE is executed autonomously by the mobile robot device 2.

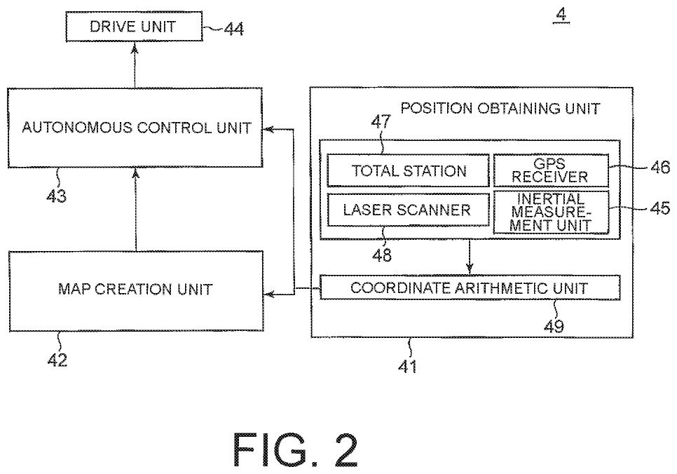

As illustrated in FIG. 2, the mobile robot device 2 includes a position obtaining unit 41, a map creation unit 42, an autonomous control unit 43, and a drive unit 44.

The position obtaining unit 41 is a device for measuring the absolute position of the mobile robot device 2 in relation to a predetermined original point. The position obtaining unit 41 also measures the relative position of an obstacle relative to the current position of the mobile robot device 2. An obstacle is an object present on or around the flight path of the mobile robot device 2 that hinders the flight of the mobile robot device 2 when the mobile robot 2 flies, and can be a mobile object, for example, a bird or another drone, as well as an object fixed to the ground, for example, a structure or a building.

Specifically, the position obtaining unit 41 includes one or a plurality of sensors used for positioning out of an inertial measurement unit 45, a Global Positioning System (GPS) receiver 46, a total station 47, and a laser scanner 48. The sensors used for positioning and included in the position obtaining unit 41 may hereinafter be collectively referred to as “positioning sensors”. The total station 47 is an auto-tracking total station. A 360-degree prism is placed at a known point, the absolute position of which has known coordinates. The total station 47 automatically tracks the 360-degree prism to measure the relative position and angle of the 360-degree prism relative to the total station 47.

The position obtaining unit 41 further includes a coordinate arithmetic unit 49. The coordinate arithmetic unit 49 is an arithmetic processing unit, and executes processing of calculating the current position (X, Y, Z) and posture (roll, pitch, yaw) of the mobile robot device 2 based on measurement data output from the positioning sensors. The coordinate arithmetic unit 49 also executes processing of calculating the velocity acceleration, the angular velocity, and the angular acceleration, which are temporal differentiation values of the calculated position and posture. The results of the calculation processing procedures are output as position measurement data. The position measurement data is output to the map creation unit 42 and the autonomous control unit 43.

The map creation unit 42 is an arithmetic processing unit, and executes processing of generating map data based on the position measurement data input from the position obtaining unit 41. The map data indicates the positional relation between the current position of the mobile robot device 2 and an inspection site. The map creation unit 42 also generates flight path data for piloting the mobile robot device 2 to an inspection site while avoiding obstacles. The location of an inspection site is received from the user interface device 3 as described later.

The autonomous control unit 43 controls the drive unit 44 based on the map data and the flight path data, which are generated by the map creation unit 42, to thereby fly the mobile robot device 2 as indicated by the flight path data. The flight of the mobile robot device may deviate from the path defined by the flight path data due to wind, air turbulence, a contact with an obstacle, and other disturbances. When the position obtaining unit 41 detects one of such disturbances encountered by the mobile robot device 2, the autonomous control unit 44 controls the drive unit 44 so that the mobile robot device 2 can fly stably by solving the disturbance. This relieves a user of the need to operate the mobile robot device 2 in order to deal with such disturbances.

The drive unit 44 includes a power unit, a lift force generation mechanism, a steering mechanism, and other components for flying the mobile robot device 2. Specifically, when the mobile robot device 2 is a rotor craft, the power unit is an engine or motor for rotating the rotor blades, the lift force generation mechanism is the rotor blades, and the steering mechanism is a mechanism for controlling the blade angles of the rotor blades. When the mobile robot device 2 is a multi-copter, the act of changing the rotation speed of the rotor blades works as the steering mechanism.

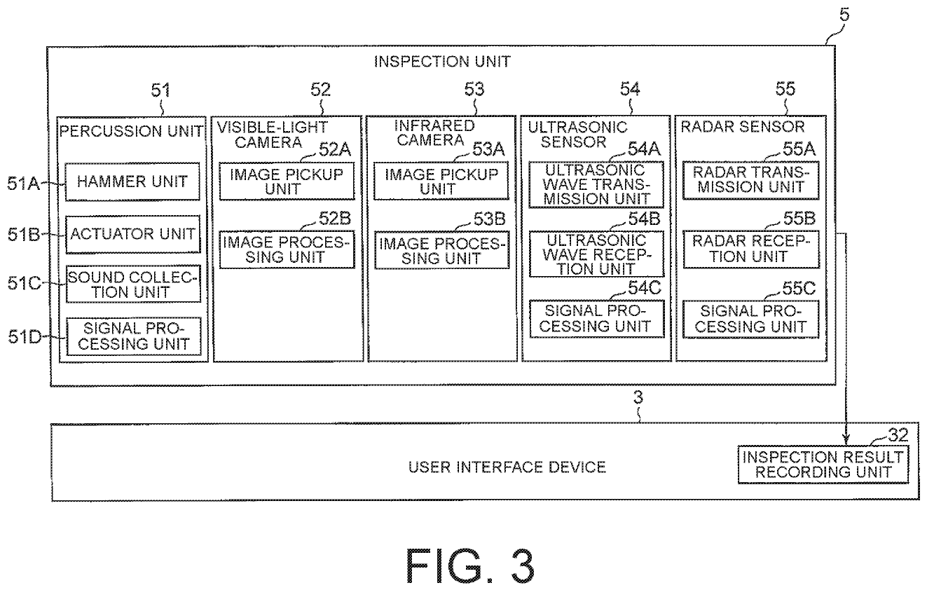

The inspection unit 5 is described with reference to FIG. 3. The inspection unit 5 includes various sensors, which measure the state of an inspection site, in particular, a percussion unit 51. The percussion unit 51 conducts percussion on an inspection site and obtains the result of the percussion. The inspection unit 5 in this embodiment includes, in addition to the percussion unit 51, a visible-light camera 52, an infrared camera 53, an ultrasonic sensor 54, and a radar sensor 55. However, the inspection unit 5 may not include the sensors other than the percussion unit 51, or may include only some of the sensors. Alternatively, the inspection unit 5 may include still other sensors. The inspection unit 5 transmits to the user interface device 3 measurement values of the various sensors, and the result of determining, for each inspection site, based on the measurement values, whether there is an anomaly.

The percussion unit 51 includes a hammer unit 51A, an actuator unit 51B, a sound collection unit 51C, and a signal processing unit 51D. The hammer unit 51A is driven by the actuator unit 51B to bump against an inspection site. The actuator unit 51B is an actuator for driving the hammer unit 51A so that the hammer unit 51A bumps against an inspection site.

The sound collection unit 51C is a microphone with which a sound issued by the bumping of the hammer unit 51A against an inspection site is collected and from which an audio signal based on the collected sound is output. The signal processing unit 51D is a processing device configured to execute given signal processing for the audio signal output from the sound collection unit 51C, to thereby execute processing of determining whether the inspection site is an anomalous site. The frequency spectrum of the audio data generally varies between an anomalous site and a site free of an anomaly. With attention paid to this, a sound issued by the bumping of the hammer unit 51A against an inspection site is collected by the sound collection unit 51C, and processing is executed to analyze the frequency of an audio signal of the collected sound. Whether the inspection site is an anomalous site can be determined from the result of the analysis.

The visible-light camera 52 includes an image pickup unit 52A and an image processing unit 52B. The image pickup unit 52A picks up a visible-light image of an inspection site and outputs a visible-light image signal. The image processing unit 52B executes given signal processing for the visible-light image signal output from the image pickup unit 52A, to thereby determine whether the inspection site is an anomalous site.

The infrared camera 53 includes an image pickup unit 53A and an image processing unit 53B. The image pickup unit 53A picks up an infrared image of an inspection site and outputs an infrared image signal. The image processing unit 53B executes given signal processing for the infrared image signal output from the image pickup unit 53A, to thereby determine whether the inspection site is an anomalous site.

The ultrasonic sensor 54 includes an ultrasonic wave transmission unit 54A, an ultrasonic wave reception unit 54B, and a signal processing unit 54C. The ultrasonic wave transmission unit 54A irradiates an inspection site with an ultrasonic wave. The ultrasonic wave reception unit 54B receives an ultrasonic wave reflected by the inspection site, and outputs a signal based on the ultrasonic wave. The signal processing unit 54C executes given signal processing for the signal output from the ultrasonic wave reception unit 54B, to thereby determine whether the inspection site is an anomalous site.

The radar sensor 55 includes a radar transmission unit 55A, a radar reception unit 55B, and a signal processing unit 55C. The radar transmission unit 55A radiates a radio wave to an inspection site. The radar reception unit 55B receives a radio wave reflected by the inspection site, and outputs a signal based on the received radio wave. The signal processing unit 55C executes given signal processing for the signal output from the radar reception unit 55B, to thereby determine whether the inspection site is an anomalous site.

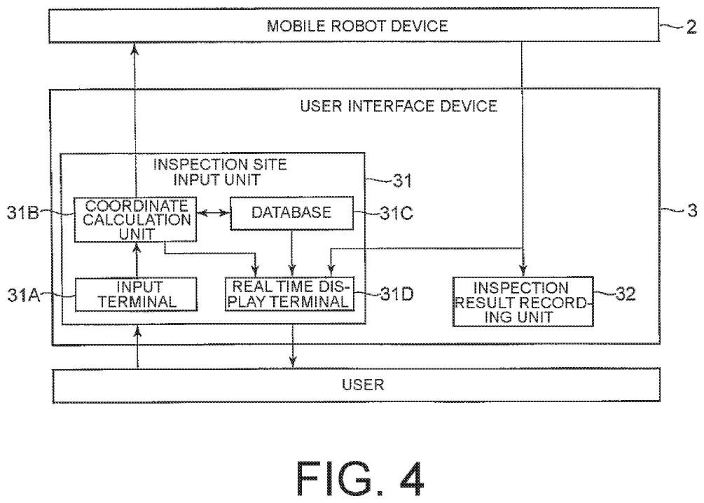

The user interface device 3 is described with reference to FIG. 4. The user interface device 3 is an information processing system made up of a plurality of computers.

The user interface device 3 includes an inspection site input unit 31 and an inspection result recording unit 32. The inspection site input unit 31 receives the specification of an inspection site from the user, and outputs inspection site data including the coordinates and the like of the inspection site to the mobile robot device 2.

To give a more detailed description, the inspection site input unit 31 includes an input terminal 31A, a coordinate calculation unit 31B, a database 31C, and a real time display terminal 31D.

The input terminal 31A is a computer including at least a keyboard, a mouse, a touch display, or other input device, for example, a personal computer, a work station, or a tablet computer. The user enters information for specifying an inspection site via the input device of the input terminal 31A. To enter the specification of an inspection site, an identifier for identifying the inspection site, for example, a number or a symbol, may be input from the input device of the input terminal 31A. Alternatively, a map containing the inspection site may be displayed on a display device of the input terminal 31A or of the real time display terminal 31D so that the inspection site is specified and entered on the map with a mouse or other pointing device.

The coordinate calculation unit 31B is a processing device configured to execute processing of converting an inspection site input on the input terminal 31A or the real time display terminal 31D into coordinate data, based on data that is stored in the database 31C. A coordinate system of the coordinate data is a coordinate system used in the calculation of the position of the mobile robot device 2.

For instance, the coordinate calculation unit 31B may execute conversion processing described below when an inspection site is entered by inputting an identifier for identifying the inspection site. Each identifier indicating an inspection site is stored in advance in the database 31C in association with coordinate data of the inspection site in the coordinate system described above. After that, the coordinate calculation unit 31B executes conversion processing in which coordinate data that is associated with an identifier input on the input terminal 31A is read out of the database 3C and is handed over to the mobile robot device 2.

The coordinate calculation unit 31B may also execute conversion processing described below when an inspection site is entered on a map displayed on the display device of the input terminal 31A or of the real time display terminal 31D. The location of each inspection site on a map displayed on the display device of the input terminal 31A or of the real time display terminal 31D is stored in advance in the database 31C in association with coordinate data of the inspection site in the coordinate system described above. When a point on the map is specified with a pointing device, the coordinate calculation unit 31B identifies which inspection site is indicated by the point specified on the map by the input, from the inspection site positions on the map stored in the database 31C, reads the coordinates of the identified inspection site out of the database 31C, and hands over the coordinates to the mobile robot device 2.

The database 31C is a database management system running on a computer. The database management system may share hardware with the input terminal 31A or the real time display terminal 31D.

The real time display terminal 31D is a computer including at least a liquid crystal display device, a cathode ray tube (CRT) display device, an organic electroluminescence (EL) display device, or other display device, for example, a personal computer, a work station, or a tablet computer. The real time display terminal 31D receives the current position, inspection result data, and other types of information from the mobile robot device 2, and displays the information in real time on the display device of the real time display terminal 31D.

The inspection result recording unit 32 is a device in which inspection result data sent from the mobile robot device 2 is recorded in association with the date of inspection, the time of inspection, the name of the inspection site, the coordinates of the inspection site, the name of the inspection, and other types of data. The inspection result recording unit 32 includes a readable/writable auxiliary storage device, for example, a hard disk drive device or a solid state drive (SSD), as a recording device. The inspection result recording unit 32 may be configured as a database management system running on the same computer system as that of the database 31C.

The operation of the inspection system 1 is described next. The user performs input operation for specifying an inspection site in a building that is an inspection target on the inspection site input unit 31 of the user interface device 3. The inspection site input unit 31 operated by the input operation outputs coordinate data of the inspection site to the mobile robot device 2. The mobile robot device 2 receives the coordinate data, and the map creation unit 42 generates map data from the coordinate data and from current position data of the mobile robot device 2 obtained by the position obtaining unit 41. It is preferred for the map creation unit 42 to update the map data at given time intervals. The autonomous control unit 43 controls the drive unit 44 based on the map data generated or updated by the map creation unit 42 to pilot the mobile robot device 2 to the inspection site. When the mobile robot device 2 arrives at the inspection site, the inspection unit 5 conducts an inspection of the inspection site, and generates inspection result data as the result of the inspection. The mobile robot device 2 transmits the inspection result data to the user interface device 3. The inspection result data is displayed to the user by the real time display terminal 31D and is also recorded by the inspection result recording unit 32.

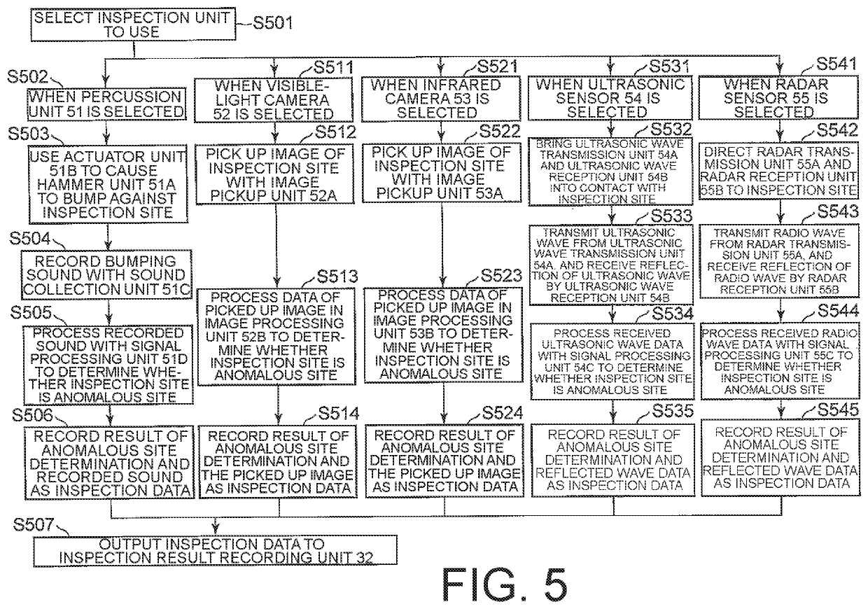

The inspection operation to be performed by the inspection unit 5 is described with reference to FIG. 5. The inspection unit 5 first selects a sensor to be used for inspection out of the percussion unit 51, the visible-light camera 52, the infrared camera 53, the ultrasonic sensor 54, and the radar sensor 55 (Step S501). The selection may be made by the user's input operation on the user interface device 3, or some or all of the sensors may be used in succession in a predetermined order for one inspection site. The operation performed when one of the sensors is selected is described here for each of the sensors.

When the selected sensor is the percussion unit 51 (Step S502), the actuator unit 51B is activated to bump the hammer unit 51A against the inspection site (Step S503). A hitting sound caused by the bumping is collected by the sound collection unit 51C to generate sound data (Step S504). The signal processing unit 51D performs signal processing on the generated sound data, thereby determining whether the inspection site is anomalous, that is, conducting anomaly determination (Step S505).

The anomaly determination can be conducted by, for example, analyzing the frequency of the audio data. The frequency spectrum of the audio data generally varies between an anomalous site and a site free of an anomaly. By utilizing this fact, the frequency spectrum is measured and recorded as a reference value for audio data of each inspection site before an anomaly occurs (e.g., immediately after the construction of the building containing the inspection site is finished). The frequency spectrum of the audio data generated in Step S504 is compared against the recorded reference value, to thereby determine whether an anomaly has occurred. When this method is used for the anomaly determination, a storage device storing the reference value of each inspection site is included in some part of the inspection system 1. The storage device may be included in, for example, the signal processing unit SD. The reference value may instead be stored in a storage device provided in the user interface device 3 to be read out of this storage device by the signal processing unit 51D as required. The reference value in this case may be stored in the same storage device as that of the database 31C or the inspection result recording unit 32, or may be stored in another storage device.

Next, the audio data generated in Step S504 and the result of the anomaly determination in Step S505 are transmitted to the user interface device 3 as inspection result data of that inspection site (Step S506). The user interface device 3 records the received inspection result data in the inspection result recording unit 32 (Step S507). The inspection result data is recorded in association with the date and time of execution of the inspection and the type of the sensor used (the percussion unit 51 in this case).

When the selected sensor is the visible-light camera (Step S511), the inspection unit 5 picks up a visible-light image of the inspection site with the image pickup unit 52A to generate image data (Step S512). The image processing unit 52B executes image processing for the image data to determine whether the inspection site the image of which has been picked up is an anomalous site (Step S513).

In the image processing of Step S513, whether an anomaly is found in the appearance of the inspection site viewed in visible light is determined. Specifically, whether the image of the inspection site contains, for example, a cracked place is determined. It is preferred in the determination of the presence/absence of a crack to enhance edges in the image of the inspection site by performing differentiation processing on the image.

The image data generated in Step S512 and the result of the determination in Step S513 are transmitted to the user interface device 3 as inspection result data of that inspection site (Step S514). The user interface device 3 records the received inspection result data in the inspection result recording unit 32 (Step S507). The inspection result data is recorded in association with the date and time of execution of the inspection and the type of the sensor used (the visible-light camera 52 in this case).

When the selected sensor is the infrared camera (Step S521), an infrared image of the inspection site is picked up with the image pickup unit 53A to generate image data (Step S522). The image processing unit 53B executes image processing for the image data to determine whether the inspection site the image of which has been picked up is an anomalous site (Step S523).

In the image processing of Step S523, it is determined whether an anomaly is found in the appearance of the inspection site viewed in infrared light. For example, an anomaly in which an air space that is not included in design is present inside an exterior wall can be caused by the flaking of concrete or the like. The flaking place easily accumulates heat because of the presence of the air space, thereby creating a temperature difference between the flaking place and a place free of flaking. This can be utilized to determine that there is a possibility of flaking in a place that is found to be higher in temperature than its surroundings as a result of measuring the temperature distribution of the inspection site from the infrared image.

The infrared image data generated in Step S522 and the result of the determination in Step S523 are transmitted to the user interface device 3 as inspection result data of that inspection site (Step S524). The user interface device 3 records the received inspection result data in the inspection result recording unit 32 (Step S507). The inspection result data is recorded in association with the date and time of execution of the inspection and the type of the sensor used (the infrared camera 53 in this case).

When the selected sensor is the ultrasonic sensor 54 (Step S531), the mobile robot device 2 brings the ultrasonic wave transmission unit 54A and the ultrasonic wave reception unit 54B into contact with the inspection site (Step S532). Next, an ultrasonic wave is emitted from the ultrasonic wave transmission unit 54A to the inspection site, and a reflected wave of the emitted wave is received by the ultrasonic wave reception unit 54B to be output as reflected wave data (Step S533). The signal processing unit 54C determines whether the inspection site is an anomalous site based on the reflected wave data (Step S534).

When reinforcing steel or the like in concrete is corroded, air may enter a gap created by the corrosion. A place that has this type of gap inside is highly reflective of ultrasonic waves. Whether there is a gap inside an exterior wall is determined by utilizing this fact. For example, reflected wave data is measured and recorded as a reference value for each inspection site before an anomaly occurs (e.g., immediately after the construction of the building containing the inspection site is finished), as is the case for the reference values for the percussion unit 51. The reflected wave data generated in Step S533 is compared against the recorded reference value, to thereby determine whether there is a gap inside. When this method is used for the determination, a storage device storing the reference value of each inspection site is included in some part of the inspection system 1. The storage device may be included in, for example, the signal processing unit 54C. The reference value may instead be stored in a storage device provided in the user interface device 3 to be read out of this storage device by the signal processing unit 54C as required. The reference value in this case may be stored in the same storage device as that of the database 31C or the inspection result recording unit 32, or may be stored in another storage device.

The reflected wave data generated in Step S533 and the result of the determination in Step S534 are transmitted to the user interface device 3 as inspection result data of that inspection site (Step S535). The user interface device 3 records the received inspection result data in the inspection result recording unit 32 (Step S507). The inspection result data is recorded in association with the date and time of execution of the inspection and the type of the sensor used (the ultrasonic sensor 54 in this case).

When the selected sensor is the radar sensor 55 (Step S541), the radar transmission unit 55A and the radar reception unit 55B are directed to the inspection site (Step S542). Next, a radio wave is transmitted from the radar transmission unit 55A to the inspection site, and the radar reception unit 55B receives a reflected wave to generate reflected wave data (Step S543). The signal processing unit 55C determines whether the inspection site is an anomalous site based on the reflected wave data (Step S544).

When reinforcing steel or the like in concrete is corroded, air may enter a gap created by the corrosion. A place that has this type of gap inside is highly reflective of radio waves as well as ultrasonic waves. Whether there is a gap inside an exterior wall is determined by utilizing this fact. For example, reflected wave data is measured and recorded as a reference value for each inspection site before an anomaly occurs (e.g., immediately after the construction of the building containing the inspection site is finished), as is the case for the reference values for the percussion unit 51. The reflected wave data generated in Step S543 is compared against the recorded reference value, to thereby determine whether there is a gap inside. When this method is used for the determination, a storage device storing the reference value of each inspection site is included in some part of the inspection system 1. The storage device may be included in, for example, the signal processing unit 55C. The reference value may instead be stored in a storage device provided in the user interface device 3 to be read out of this storage device by the signal processing unit 55C as required. The reference value in this case may be stored in the same storage device as that of the database 31C or the inspection result recording unit 32, or may be stored in another storage device.

The reflected wave data generated in Step S543 and the result of the determination in Step S544 are transmitted to the user interface device 3 as inspection result data of that inspection site (Step S545). The user interface device 3 records the received inspection result data in the inspection result recording unit 32 (Step S507). The inspection result data is recorded in association with the date and time of execution of the inspection and the type of the sensor used (the radar sensor 55 in this case).

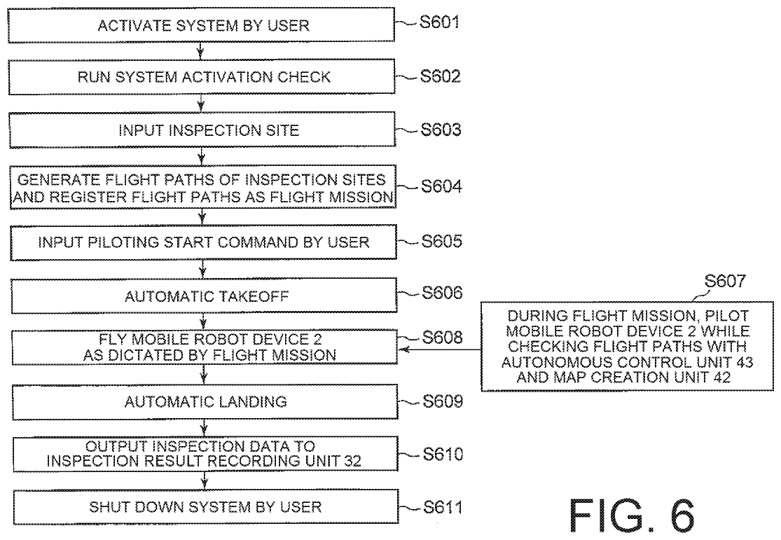

The operation of the mobile robot device 2 is described next with reference to FIG. 6. When the user activates the mobile robot device 2 (Step S601), the mobile robot device 2 runs an activation check on its own system (Step S602). The user inputs one or a plurality of inspection sites via the user interface device 3, and the user interface device 3 hands over coordinate data of each input inspection site to the autonomous control unit 43 (Step S603). The autonomous control unit 43 generates a series of flight paths along which the mobile robot device 2 is to be piloted to the inspection sites, and registers the flight paths as a flight mission (Step S604).

When the user inputs, in this state, via the user interface device 3, a command to start piloting the mobile robot device 2 to the inspection sites (Step S605), the autonomous control unit 43 controls the drive unit 44 so that the mobile robot device 2 autonomously takes off (Step S606). The autonomous control unit 43 subsequently pilots the mobile robot device 2 to the inspection sites as dictated by the flight mission registered in Step S604. During the piloting, the position obtaining unit 41 periodically obtains the current position of the mobile robot device 2. The map creation unit 42 generates/updates map data based on the coordinate data of the inspection site received in Step S603 and on the current position in response to the obtaining of the current position by the position obtaining unit 41.

The autonomous control unit 43 pilots the mobile robot device 2 sequentially to the inspection sites based on the map data and on the flight mission registered in Step S604. The mobile robot device 2 uses the inspection unit 5 to perform inspection work at each inspection site. Time information about the time when the inspection work has been conducted is obtained and recorded at this point. During the execution of the flight mission, the autonomous control unit 43 performs control to pilot the mobile robot device 2 along the flight paths described above based on the positioning result of the position obtaining unit 41 and the map data of the map creation unit 42, while maintaining the flight safety of the mobile robot device 2 (Step S607 and Step S608).

When all phases of the registered flight mission are completed, the autonomous control unit 43 causes the mobile robot device 2 to land autonomously (Step S609). Inspection result data obtained at each inspection site during the flight mission may be recorded in the inspection result recording unit 32 by performing wireless data communication each time the data is obtained, or may be stored in a storage device included in the mobile robot device 2 to be recorded in the inspection result recording unit 32 by connecting the mobile robot device 2 and the user interface device 3 to each other with a wired or wireless data communication line after the flight mission is completed (Step S610). The autonomous control unit 43 then executes the shutting down of the mobile robot device 2 by following a command input by the user via the user interface device 3 (Step S611).

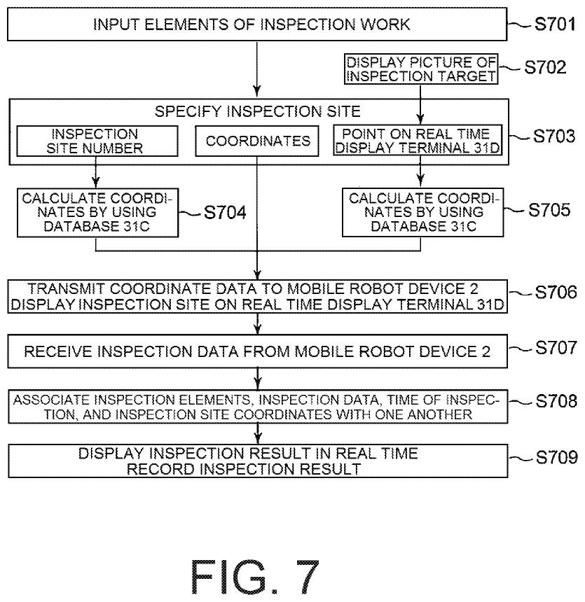

The operation of the user interface device 3 is described next with reference to FIG. 7. The user inputs via the input terminal 31A elements of inspection work, for example, the date of inspection, the name of the inspection, and sensors to be used for the inspection (the percussion unit 51 plus one or a plurality of sensors out of the visible-light camera 52, the infrared camera 53, the ultrasonic sensor 54, and the radar sensor 55) (Step S701). The user also inputs information for specifying an inspection site to the user interface device 3. The user may input the information by inputting an identifier of the inspection site, or coordinate data of the inspection site, via the input terminal 31A. Alternatively, the user may input the information by specifying a point on a map displayed on the display device of the real time display terminal 31D with a pointing device or the like (Step S702 and Step S703). When a map is displayed on the display device of the input terminal 31A or of the real time display terminal 31D, it is preferred to display, for each inspection site, an illustration, a photograph, or the like that depicts an inspection target located at the inspection site in association with the inspection site on the map.

The map displayed in this manner helps the user to avoid specifying a wrong inspection site. When the coordinates of an inspection site are directly input, the user interface device 3 hands over the coordinates to the mobile robot device 2 as coordinate data without modifying the coordinates. When an inspection site is specified with the use of an identifier, the coordinate calculation unit 31B refers to the data stored in the database 31C to obtain coordinate data that is associated in advance with the inspection site indicated by the specified identifier, and hands over the coordinate data to the mobile robot device 2 (Step S704). When an inspection site is specified as a point on the map, the coordinate calculation unit 31B compares the coordinates of the point on the map to the coordinates of inspection sites on the map, which are stored in the database 31C in advance. The coordinate calculation unit 31B then determines that an inspection site closest to the specified point is specified, reads coordinate data of the inspection site out of the database 31C, and hands over the coordinate data to the mobile robot device 2 (Step S705).

The coordinate calculation unit 31B hands over the coordinate data of each inspection site to the real time display terminal 31D as well as to the mobile robot device 2. The real time display terminal 31D displays the positional relation between the current position of the mobile robot device 2 and the location of each inspection site on the display device (Step S706). The user viewing the display can check whether the intended inspection site is specified correctly.

The subsequent operation of the mobile robot device 2 follows the flow chart of FIG. 6, and the mobile robot device 2 flies autonomously to obtain inspection result data at each inspection site, and transmits the inspection result data to the user interface device 3 via a wireless data line. The user interface device 3 receives the inspection result data (Step S707), and displays the inspection result data on the display device of the real time display terminal 31D. The user interface device 3 also records the inspection result data in the inspection result recording unit 32 in association with the date of inspection, the name of the inspection, the sensors used in the inspection, the time of inspection, and the coordinates of the inspection site (Step S708 and Step S709).

According to the inspection system 1, the mobile robot device 2 autonomously flies to an inspection site specified in advance by the user interface device 3 to obtain inspection result data. The user therefore is not required to perform the operation of piloting the mobile robot device 2 to the inspection site. This means that an inspection result can be obtained irrespective of the skill level of the user. In addition, with the mobile robot device 2 operated autonomously, the user is not required to make decisions during the flight, and the length of inspection work can consequently be cut short.

This concludes the description of this invention through an embodiment, but this invention is not limited thereto. Various possible modifications can be made to the inspection system 1. To give an example, the inspection system 1, which includes the percussion unit 51, the visible-light camera 52, the infrared camera 53, the ultrasonic sensor 54, and the radar sensor 55 as the inspection unit 5 in the description given above, may include other sensors.

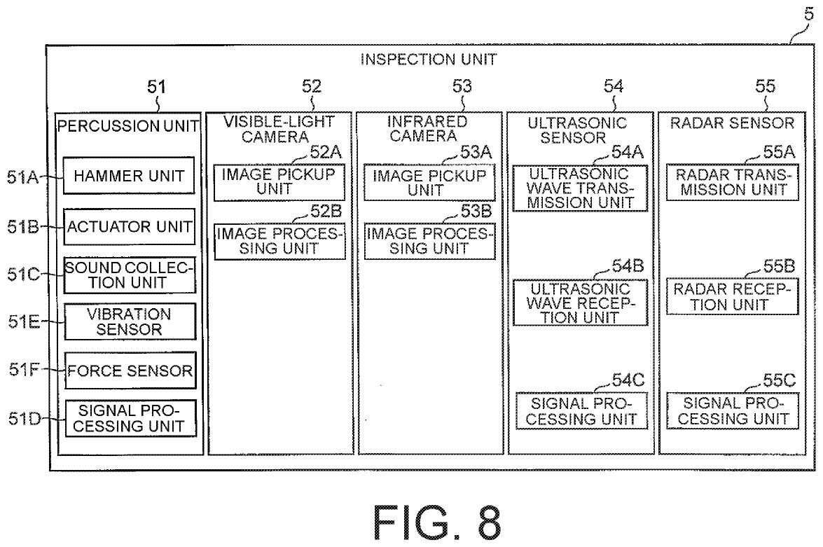

For instance, the percussion unit 51, in which an impact generated by the bumping of the hammer unit 51A is input as a sound by the sound collection unit 51C in the description given above, may include a sensor by which the impact is input in another form. Specifically, the percussion unit 51 may further include a vibration sensor 51E and a force sensor 51F as illustrated in FIG. 8. The percussion unit 51 may instead include one of the vibration sensor 51E and the force sensor 51F, or may include a combination of two components out of the sound collection unit 51C, the vibration sensor 51E, and the force sensor 51F.

The vibration sensor 51E is brought into contact with an inspection site, or a place in the vicinity of the inspection site, before the hammer unit 51A bumps against the inspection site in the inspection. It is preferred for the vibration sensor 51E to be in contact with a place that is in the vicinity of the point of the bumping of the hammer unit 51A and at which a contact with the hammer unit 51A is avoided. With the vibration sensor 51E brought into contact in this manner, the actuator unit 51B causes the hammer unit 51A to bump against the inspection site. Vibration is generated by the bumping at and around the inspection site in a building that is the inspection target. The vibration is measured by the vibration sensor 51E to be output as vibration data. The vibration data varies between the case in which the inspection site has an anomaly and the case in which the inspection site is free of an anomaly. By utilizing this fact, vibration data prior to an anomaly is stored in advance in, for example, the database 31C as a reference value for each inspection site so that whether there is an anomaly can be determined from a comparison between the reference value and the vibration data generated by the vibration sensor 51E during the inspection.

The force sensor 51F, too, is brought into contact with the same place of contact as in the case of the vibration sensor 51E, prior to inspection, to measure the magnitude of a force transmitted by the hammer unit 51A to the vicinity of the inspection site. Force sense data output by the force sensor 51F, as does the vibration data output from the vibration sensor 51E, varies between the case in which the inspection site has an anomaly and the case in which the inspection site is free of an anomaly. The same method of determining the presence/absence of an anomaly that is used with the vibration sensor 51E described above applies to the force sensor 51F.

The inspection system 1 described above, in which the user interface device 3 is an information processing system made up of a plurality of computers in the description given above, may use a single computer as the user interface device 3.

The inspection system 1 described above, in which the position obtaining unit 41 is included in the mobile robot device 2 and travels together with the mobile robot device 2 in the description given above, may place the position obtaining unit 41 outside the mobile robot device 2. For example, the position of the mobile robot device 2 is measured periodically or continuously while automatically tracking the mobile robot device 2 with the use of a measurement device placed at a known point the coordinates of which are known in advance, and the absolute coordinates of the mobile robot device 2 are obtained based on the absolute coordinates of the measurement device (the known point) and relative coordinates of the mobile robot device 2 relative to the measurement device. The measurement device periodically or continuously obtains relative coordinates of the mobile robot device 2 relative to itself, and transmits the obtained coordinates to the coordinate arithmetic unit 49 of the mobile robot device 2 via a wireless data communication line. The coordinate arithmetic unit 49 calculates the absolute coordinates of the mobile robot device 2 from the received relative coordinates and from the absolute coordinates of the known point, which are stored in advance in a storage device of the mobile robot device 2. An auto-tracking total station, for example, can be used as this type of measurement device. While an auto-tracking total station is placed at a known point, a 360-degree prism is placed in, for example, a bottom portion of the mobile robot device 2. The relative position and angle of the mobile robot device 2 measured from the total station and the absolute position of the known point at which the total station is placed are transmitted as positioning data to the mobile robot device 2 via a wireless data communication line. The coordinate arithmetic unit 49 in the mobile robot device 2 calculates the current position of the mobile robot device 2 from the received positioning data.

In the inspection system 1 described above, data is communicated between the mobile robot device 2 and the user interface device 3 via a wireless data communication line. However, the line used for the data communication is not always required to be a wireless line, and may be a wired line. A cable containing a data communication line connects the mobile robot device 2 and the user interface device 3 to each other during a flight mission in this case. When such a cable is provided and an electric motor is used as a power source of the drive unit 44, the cable may further contain a power supply line inside.

Some or all of the embodiments described above may also be described by the following supplementary notes, but are not limited to the following configurations.

(Supplementary Note 1)

An inspection system, comprising:

a mobile robot device;

a user interface device; and

position obtaining means for obtaining a current position of the mobile robot device, wherein the mobile robot device includes:
inspection means including, at least, percussion means for inspecting an inspection site by hitting an anomalous site;
flying means for flying the mobile robot device;
map creation means for generating map data, which indicates a positional relation between the current position of the mobile robot device and an inspection site specified via the user interface device, based on the specified inspection site and on the current position obtained by the position obtaining means; and
an autonomous control means for controlling the flying means based on the current position and the map data so that the mobile robot device autonomously travels to a point at which an inspection of the inspection site is executable with the inspection means, and

wherein the user interface device includes:
inspection site input means for receiving input of a location of the inspection site by a user; and
inspection result recording means for recording the location of the inspection site and output of the inspection means in association with each other

(Supplementary Note 2)

An inspection system according to Supplementary Note 1, wherein the inspection means further includes, in addition to the percussion means, at least one of a visible-light camera, an infrared camera, an ultrasonic sensor, a vibration sensor, a force sensor, or a radar sensor.

(Supplementary Note 3)

An inspection system according to Supplementary Note 1 or 2,

wherein the position obtaining means includes at least one of an inertial measurement unit, a laser scanner, a Global Positioning System (GPS) receiver, or a total station, and

wherein at least some components of the position obtaining means are mounted on the mobile robot device.

(Supplementary Note 4)

An inspection system according to any one of Supplementary Notes 1 to 3, wherein the percussion means includes:

a hammer to be bumped against the inspection site:

an actuator configured to drive the hammer so that the hammer is bumped against the inspection site; and

a percussion sensor configured to measure an impact of the bump of the hammer against the inspection site.

(Supplementary Note 5)

An inspection system according to Supplementary Note 4, wherein the percussion sensor includes at least one of:

a microphone configured to collect a sound that is issued when the hammer is bumped against the inspection site:

a vibration sensor configured to measure vibration that is caused when the hammer is bumped against the inspection site; or

a force sensor configured to measure a magnitude of a force that is transmitted through the inspection site when the hammer is bumped against the inspection site.

(Supplementary Note 6)

A mobile robot device to be used together with a user interface device and position obtaining means for obtaining a current position of the mobile robot device, the mobile robot device comprising:

inspection means including, at least, percussion means for inspecting an inspection site by hitting an anomalous site:

flying means for flying the mobile robot device;

map creation means for generating map data, which indicates a positional relation between the current position of the mobile robot device and an inspection site specified via the user interface device, based on the specified inspection site and on the current position obtained by the position obtaining means; and

autonomous control means for controlling the flying means based on the current position and the map data so that the mobile robot device autonomously travels to a point at which an inspection of the inspection site is executable with the inspection means,

wherein the user interface device includes:
inspection site input means for receiving input of a location of the inspection site by a user; and
inspection result recording means for recording the location of the inspection site and output of the inspection means in association with each other.

(Supplementary Note 7)

A mobile robot device according to Supplementary Note 6, wherein the inspection means further includes, in addition to the percussion means, at least one of a visible-light camera, an infrared camera, an ultrasonic sensor, a vibration sensor, a force sensor, or a radar sensor.

(Supplementary Note 8)

A mobile robot device according to Supplementary Note 6 or 7,

wherein the position obtaining means includes at least one of an inertial measurement unit, a laser scanner, a Global Positioning System (GPS) receiver, or a total station, and

wherein at least some components of the position obtaining means are mounted on the mobile robot device.

(Supplementary Note 9)

A mobile robot device according to any one of Supplementary Notes 6 to 8, wherein the percussion means includes:

a hammer to be bumped against the inspection site;

an actuator configured to drive the hammer so that the hammer is bumped against the inspection site; and

a percussion sensor configured to measure an impact of the bump of the hammer against the inspection site.

(Supplementary Note 10)

A mobile robot device according to Supplementary Note 9, wherein the percussion sensor includes at least one of:

a microphone configured to collect a sound that is issued when the hammer is bumped against the inspection site;

a vibration sensor configured to measure vibration that is caused when the hammer is bumped against the inspection site; or

a force sensor configured to measure a magnitude of a force that is transmitted through the inspection site when the hammer is bumped against the inspection site.

(Supplementary Note 11)

An inspection method, comprising the steps of:

receiving, by a user interface device, input for specifying an inspection site;

causing a mobile robot device to autonomously fly and travel to the inspection site, based on the input to the user interface device and a current position of the mobile robot device; and

inspecting the inspection site with one or a plurality of inspection means, which include percussion means provided in the mobile robot device.

(Supplementary Note 12)

An inspection method according to Supplementary Note 11,

wherein the mobile robot device includes, in addition to the percussion means, at least one of a visible-light camera, an infrared camera, an ultrasonic sensor, a vibration sensor, a force sensor, or a radar sensor as the inspection means, and

wherein the step of inspecting includes conducting, by the mobile robot device, in addition to inspection with the percussion means, inspection with inspection means other than the percussion means.

(Supplementary Note 13)

An inspection method according to Supplementary Note 11 or 12, further including obtaining the current position of the mobile robot device with at least one of an inertial measurement unit, a laser scanner, a Global Positioning System (GPS) receiver, or a total station.

(Supplementary Note 14)

An inspection method according to any one of Supplementary Notes 11 to 13, wherein the inspection with the percussion means includes a step of driving a hammer with an actuator so that the hammer is bumped against the inspection site, and measuring an impact of the bumping with a sensor.

(Supplementary Note 15)

An inspection method according to Supplementary Note 14, wherein the measurement with the sensor includes at least one of the steps of;

collecting, with a microphone, a sound that is issued when the hammer is bumped against the inspection site;

measuring, with a vibration sensor, vibration that is caused when the hammer is bumped against the inspection site; and

measuring, with a force sensor, a magnitude of a force that is transmitted through the inspection site when the hammer is bumped against the inspection site.

This application is based upon and claims the benefit of priority from Japanese Patent Application No. 2016-119753, filed on Jun. 16, 2016, the disclosure of which is incorporated herein in its entirety by reference.

### EXPLANATION OF REFERENCE SIGNS

1 inspection system
2 mobile robot device
3 user interface device
4 flight unit
5 inspection unit
31 inspection site input unit
31A input terminal
31B coordinate calculation unit
31C database
31D real time display terminal
32 inspection result recording unit
41 position obtaining unit
42 map creation unit
43 autonomous control unit
44 drive unit
45 inertial measurement unit
46 GPS receiver
47 total station
48 laser scanner
49 coordinate arithmetic unit
51 percussion unit
51A hammer unit
51B actuator unit
51C sound collection unit
51D, 54C, 55C signal processing unit
51E vibration sensor
51F force sensor
52 visible-light camera
52A, 53A image pickup unit
52B, 53B image processing unit
53 infrared camera
54 ultrasonic sensor
54A ultrasonic wave transmission unit
54B ultrasonic wave reception unit
55 radar sensor
55A radar transmission unit
55B radar reception unit

1. An inspection system, comprising:
a mobile robot device;
a user interface device; and
position obtaining means for obtaining a current position of the mobile robot device,
wherein the mobile robot device includes:
inspection means including, at least, percussion means for inspecting an inspection site by hitting an anomalous site;
flying means for flying the mobile robot device;
map creation means for generating map data, which indicates a positional relation between the current position of the mobile robot device and an inspection site specified via the user interface device, based on the specified inspection site and on the current position obtained by the position obtaining means; and
an autonomous control means for controlling the flying means based on the current position and the map data so that the mobile robot device autonomously travels to a point at which an inspection of the inspection site is executable with the inspection means, and
wherein the user interface device includes:
inspection site input means for receiving input of a location of the inspection site by a user; and
inspection result recording means for recording the location of the inspection site and output of the inspection means in association with each other.

2. An inspection system according to claim 1, wherein the inspection means further includes, in addition to the percussion means, at least one of a visible-light camera, an infrared camera, an ultrasonic sensor, a vibration sensor, a force sensor, or a radar sensor.

3. An inspection system according to claim 1,
wherein the position obtaining means includes at least one of an inertial measurement unit, a laser scanner, a Global Positioning System (GPS) receiver, or a total station, and
wherein at least some components of the position obtaining means are mounted on the mobile robot device.

4. An inspection system according to claim 1, wherein the percussion means includes:
a hammer to be bumped against the inspection site;
an actuator configured to drive the hammer so that the hammer is bumped against the inspection site; and
a percussion sensor configured to measure an impact of the bump of the hammer against the inspection site.

5. An inspection system according to claim 4, wherein the percussion sensor includes at least one of:
a microphone configured to collect a sound that is issued when the hammer is bumped against the inspection site;
a vibration sensor configured to measure vibration that is caused when the hammer is bumped against the inspection site; or
a force sensor configured to measure a magnitude of a force that is transmitted through the inspection site when the hammer is bumped against the inspection site.

6. A mobile robot device to be used together with a user interface device and position obtaining means for obtaining a current position of the mobile robot device, the mobile robot device comprising:
inspection means including, at least, percussion means for inspecting an inspection site by hitting an anomalous site;
flying means for flying the mobile robot device;
map creation means for generating map data, which indicates a positional relation between the current position of the mobile robot device and an inspection site specified via the user interface device, based on the specified inspection site and on the current position obtained by the position obtaining means; and
autonomous control means for controlling the flying means based on the current position and the map data so that the mobile robot device autonomously travels to a point at which an inspection of the inspection site is executable with the inspection means,
wherein the user interface device includes:
inspection site input means for receiving input of a location of the inspection site by a user; and
inspection result recording means for recording the location of the inspection site and output of the inspection means in association with each other.

7. A mobile robot device according to claim 6, wherein the inspection means further includes, in addition to the percussion means, at least one of a visible-light camera, an infrared camera, an ultrasonic sensor, a vibration sensor, a force sensor, or a radar sensor.

8. A mobile robot device according to claim 6,
wherein the position obtaining means includes at least one of an inertial measurement unit, a laser scanner, a Global Positioning System (GPS) receiver, or a total station, and
wherein at least some components of the position obtaining means are mounted on the mobile robot device.

9. A mobile robot device according to claim 6, wherein the percussion means includes:
a hammer to be bumped against the inspection site;
an actuator configured to drive the hammer so that the hammer is bumped against the inspection site; and
a percussion sensor configured to measure an impact of the bump of the hammer against the inspection site.

10. An inspection method, comprising the steps of:
receiving, by a user interface device, input for specifying an inspection site;
causing a mobile robot device to autonomously fly and travel to the inspection site, based on the input to the user interface device and a current position of the mobile robot device; and
inspecting the inspection site with one or a plurality of inspection means, which include percussion means provided in the mobile robot device.
